(19) United States
(12) Patent Application Publication
(10) Pub. No.: US 2009/0099911 A1
(43) Pub. Date: Apr. 16, 2009

(54) Systems and Methods for Managing Advertising Content Corresponding to Streaming Media Content

(75) Inventor: Takaaki Ota, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 11/871,060

(22) Filed: Oct. 11, 2007

(51) Int. Cl. G06Q 30/00

(52) U.S. Cl. 705/14

(57) ABSTRACT

A media server is accessed by a user device over a network. Advertising content is automatically received from the server and stored by the user device, where the advertising content is associated with streaming media content. Following a request for the streaming media content, at least a portion of the received advertising content is presented on the user device while the requested streaming media content begins to be downloaded or queued. As soon as presentation of the advertising content concludes, the requested streaming media content is presented on the user device without network-related delay.

### FIELD OF THE INVENTION

The present invention relates, in general, to managing advertising content and, more particularly, to systems and methods for managing advertising content corresponding to streaming media content.

### BACKGROUND OF THE INVENTION

Distribution of streaming digital media (audio and video) has increased dramatically with the technological networking improvements. Streaming media is media that is consumed (heard or viewed) as it is being delivered. Steaming media is typical found in discrete segments or clips, although feature-length streams are becoming more common. Streaming is more a property of the delivery system than the media itself. The distinction is usually applied to content that is distributed over computer networks, with most other systems being either inherently streaming, such as radio and television, or inherently non-streaming.

Moreover, various protocols have been developed for streaming digital content. For example, datagram protocols, such as the User Datagram Protocol (UDP), send the media stream as a series of small packets. Real-Time Streaming Protocol (RTSP), Real-time Transport Protocol (RTP) and the Real-time Transport Control Protocol (RTCP) are also commonly-used for streaming digital content over networks. Other streaming protocols include Hypertext Transfer Protocol (HTTP) and Microsoft Media Server (MMS) protocol.

Streaming media is experienced in a server-client environment, using one of the aforementioned protocols, in which a server or other content source delivers the streaming media to a client-side system (e.g., personal computer) upon request. Once a host-client connection is established, the requested media is delivered to a streaming media player (e.g., Windows Media Player™, Flash Player™, Shockwave™, etc.) on the client-side, which in turn decodes and presents the streaming media to the user.

One growing practice is the incorporation of digital advertisements which accompany such streaming digital media. Typically, the digital advertisement will be downloaded prior to the requested streaming media, such that the user will have to view the full advertisement prior to being able to access or receive the requested media content. However, this practice tends to significantly increase the delay involved since some portion of the digital advertisement first has to be buffered or queued before it can begin to playback. And even after the advertisement begins to be presented, the remaining portion of the digital advertisement still has to be downloaded while the requested streaming media is itself attempting to download. Thus, the requested streaming media has to compete with available bandwidth with the prefacing digital advertisements. In a bandwidth-limited networking environment, as if often the case, this practice tends to cause excess network-related delays.

### SUMMARY OF THE INVENTION

A method and device for managing digital advertising corresponding to streaming media content is disclosed and claimed herein. In one embodiment, a method for streaming media content from a server to a user device over a network comprises accessing, by the user device, the server over the network. The method further comprises receiving, automatically, advertising content from the server, storing the advertising content in a local storage of the user device, and transmitting a request for streaming media content to the server based on a user request. The method also comprises presenting at least a portion of said advertising content on the display in response to said request, and receiving the requested streaming media content during said presenting of the advertising content.

Other aspects, features, and techniques of the invention will be apparent to one skilled in the relevant art in view of the following detailed description of the invention.

### BRIEF DESCRIPTION OF THE DRAWINGS

FIG. 1 depicts a simplified diagram of a system for implementing one or more aspects of one embodiment of the invention;

FIG. 2 depicts another embodiment of a system for implementing one or more aspects of the invention;

FIG. 3 depicts a flow diagram of a process for implementing one embodiment of the invention; and

FIG. 4 depicts a flow diagram of a process for implementing another embodiment of the invention.

### DETAILED DESCRIPTION OF EXEMPLARY EMBODIMENTS

As will be described in more detail herein, one aspect of the invention relates to accesses a media server over a network, wherein the media server is configured to provide streaming media content over the network. In one embodiment, after accessing the media server, certain advertising content associated with the streaming media content is downloaded from the media server, or otherwise cached on a user device. In certain embodiments, the advertising content may be in the form of individual audio/video clips relating to different products and/or services.

In one embodiment, a request made to the media server to receive the streaming media content may result in the locally cached advertising content associated with the requested streaming media to be presented to the user prior to making the requested streaming media content available. In one embodiment, the particular advertising content to be presented to the user may be based on an instruction received from the server itself. Since the cached advertising content is locally available, it may be immediately presented to the user without any network-related delay.

Another aspect of the invention relates to downloading or queuing the requested streaming media content while the aforementioned advertising content is still being presented to the user, thereby maximizing the amount of bandwidth allocated to the streaming of the request streaming media content, and minimizing the amount of any network-related delay. In one embodiment, the requested streaming media content may be presented directly after the conclusion of the advertisement playback since the requested streaming media began streaming and was allowed to queue while the presentation of the advertisement content was ongoing.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

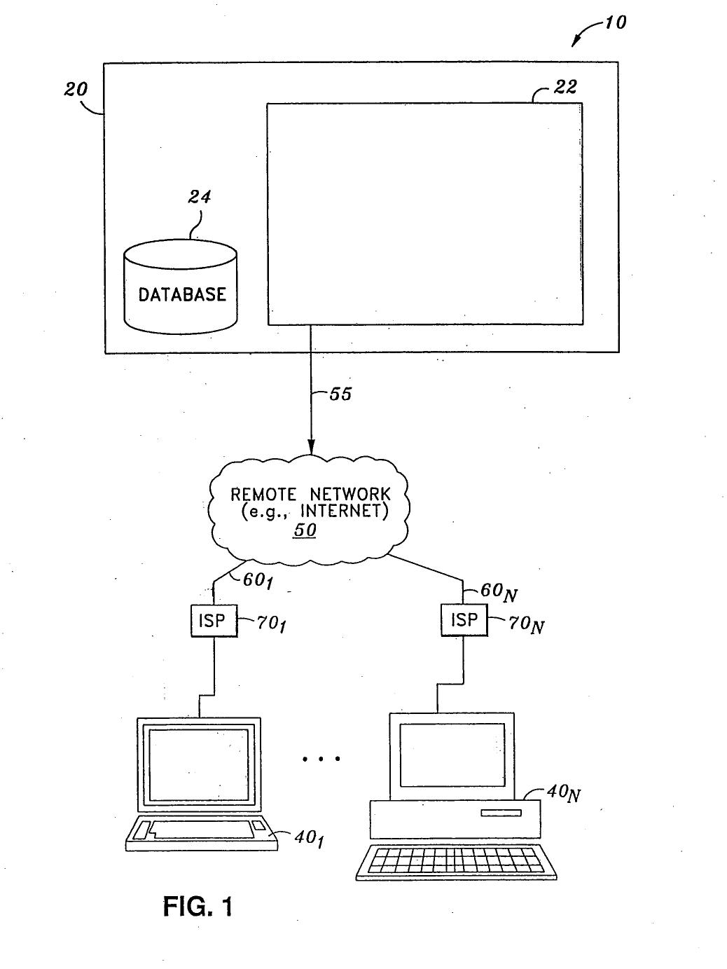

Referring now to the drawings, FIG. 1 shows a system block diagram of one embodiment of an information distribution system 10 in which the system and method of the invention may be used. In the embodiment of FIG. 1, system 10 comprises a remote server 20 in communication with one or more user computer systems 40₁-40_{N} (“40”) via network 50. It should be appreciated that user computer systems 40 may communicate with remote server 20 over any type of network connection, including a wide area network, local area network, or the like.

The remote server 20 may include computer readable instructions for generating and displaying one or target websites 22 to the user computers 40. In one embodiment, the remote server 20 may further include one or more databases 24 for storing data such as, for example, user data and/or target website 22 data. Additionally, databases 24 may contain digital media that is accessible for downloading and/or streaming, as will be described in more detail below. While for brevity remote server 20 is referred to in the singular, it should equally be appreciated that remote server 20 may be comprised of a plurality of individual computers or servers.

Remote server 20 may be connected to a remote network 50 (e.g., the Internet) or a remote site (e.g., a satellite, which is not shown in FIG. 1) via communication link 55. The remote network 50 or remote site may be used to allow the remote server 20 to provide a wider variety of computer software, content, etc. to the one or more user devices 40. In addition, user devices 40 may be coupled to the remote network via communication link 60₁-60_{N} and internet service provider (ISP) 70₁-70_{N}. It should be appreciated that user devices 40 may similarly include network-enabled mobile devices, including cellular telephones, smart phones, display pagers, radio frequency (RF) devices, infrared (IR) devices, personal digital assistants (PDAs), handheld computers, laptop computers, wearable computers, tablet computers, integrated devices combining one or more of the preceding devices, and the like. The user devices 40 may also include digital video recorders (DVR) or the like where the server 20 corresponds to a internet protocol television (IPTV) server. As is know, IPTV is a television service transmitted over an IP network (private network or public Internet) via an IP multicast or unicast mechanism.

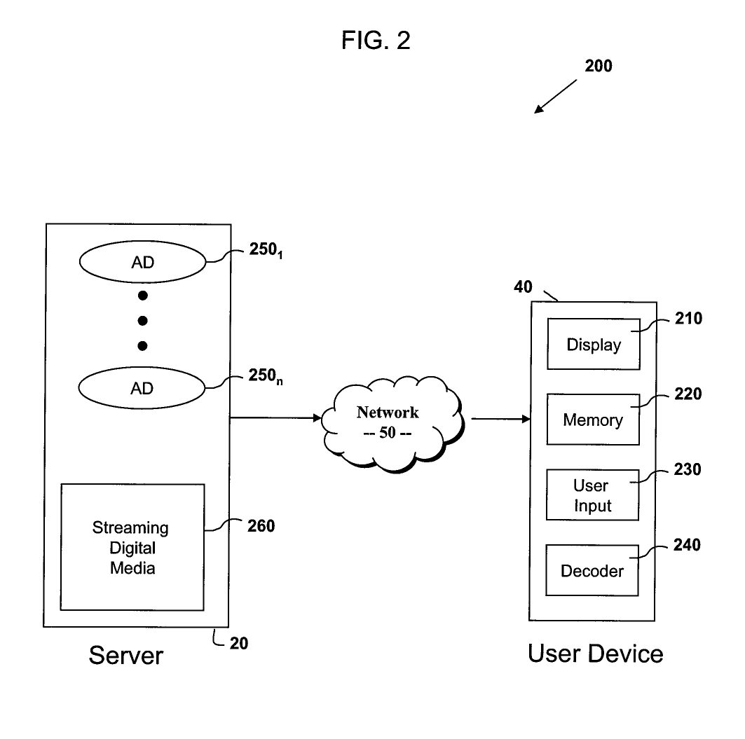

FIG. 2 depicts another embodiment of the information distribution system 10 of FIG. 1 in which server 20 is in communication with a user device 40 via network 50. As depicted in the embodiment of FIG. 1, the user device 40 includes a display 210 for presenting streaming video media and other content to a user. The user device 40 further includes a local storage 220, a user input 230 for enabling a user to select a particular stream to receive, and a decoder 240 (e.g., media player) for decoding streaming media.

First with respect to the local storage 220, it may include a volatile memory (e.g., random access memory), and/or any known non-volatile memory, such as a hard disk drive, a digital disk drive, a tape drive, a zip drive, a jazz drive, a digital video disk (DVD) drive, a solid state memory device, a magneto-optical disk drive, a high density floppy drive, a high capacity removable drive, a low capacity media device, and/or any combination thereof.

With respect to the user input 230, it may include any combination of a keyboard, mouse, touch screen, voice command input, etc. The user input 230 may similarly be used to direct a browser application executing on the user device 40 to one or more network resources, such as web pages, from which streaming media may be accessed. In certain embodiments, the user input 230 may be used to send streaming media requests to the server 20 in the form of a command, such as a Universal Plug and Play (UPnP) command, an HTTP command, an RTSP command, a UDP command, etc.

Referring now to server 20 of FIG. 2, in one embodiment the server may generate or host a particular web page, collection of web pages or network domain. One or more forms of advertising content 250₁-250ₙ (“250”) may be maintained by the server 20 (and/or database 24 of FIG. 1), such as audio/video clips corresponding to a particular product or service. Such clips may be formatted as Moving Picture Experts Group (MPEG), Advanced Systems Format (ASF), Audio Video Interleave (AVI), or any other known video encoding format. Similarly, server 20 may contain one streaming media 260, which may correspond to a motion picture content, episodic video content, news footage, or any other form of audio/video streamable content.

Much of the available online streaming content, including streaming media 260, is available only after the user is presented with a relatively short advertising audio/visual clip, such as advertising content 250. This is particularly the case when the streaming media in question is available to users for free. Such advertising clips, however, tend to be much shorter in length than the length of requested streaming video content. Based on this fact, one aspect of the invention is to download and cache various advertising clips during otherwise inactive times so that the advertising clips are immediately playable if and when a user selects to receive some associated streaming content. Since the advertising clip is locally available, it will begin to play immediately thereby decreasing the download latency involved in initiating the presentation. In addition, all of the user's available bandwidth will be used to begin downloading the requested streaming content in the background while the advertising clip is being played, thereby also decreasing the download latency of the overall presentation. In the context of IPTV, the advertising clips may correspond to one or more commercials which are associated with or otherwise provided in connection with some television-based content.

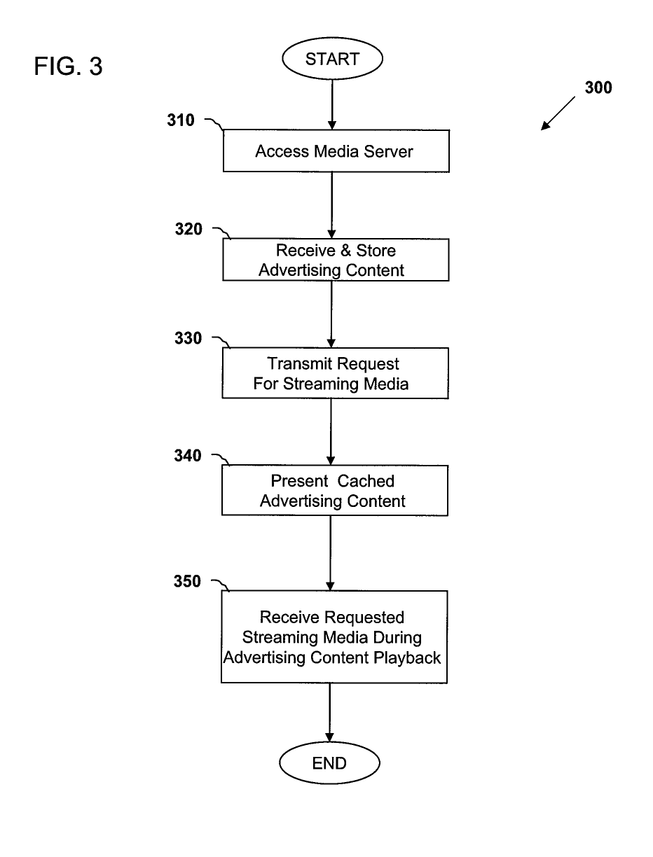

To that end, FIG. 3 depicts one embodiment of a process 300 for receiving streaming content in accordance with the principles of the invention. In particular, process 300 begins at block 310 with the user device (e.g., user device 40) accesses a media server (e.g., server 20) over a network (e.g., network 50). As previously mentioned, the server 20 (or an associated web page) may be accessible using a application program executing on the user device 40, such as a web browser. It should be appreciated that any known means of accessing a media server over a network, such as the Internet, similarly may be used.

Once the server has been accessed, process 300 continues to block 320 where advertising content, such as advertising content 250, may be received from the server over the network. Thereafter, the advertising content may be cached or otherwise saved locally on the user device. In one embodiment, the downloaded/caching of this advertising content may occur automatically as a background application process and/or without the user's knowledge. For example, the downloading/caching of the advertising content may occur automatically in response to an indication from the server that such advertising content should be received.

In certain embodiments, the advertising content 250 may be downloaded during idle communication periods, or otherwise inactive or bandwidth-rich periods. Such periods may be referred to as idle even though some relatively low amount of network activity may be occurring. It should further be appreciated that advertising content may be persistent between different sessions, and that the operation of block 320 may be to update already-stored advertising content. In this fashion, the advertising content may be dynamically changed based on availability of new content, a predetermined rotation of advertisements, or any other criteria.

It should be appreciated that the advertising content to be cached at block 320 may be in the form of one or more individual audio/video clips relating to different products and/or services. It should further be appreciated that each individual clip may be stored and catalogued in a local storage (e.g., local storage 220) of the user device using an advertisement identification number. In one embodiment, this advertisement identification number may be comprised of one or more of the following: a first portion corresponding to the accessed media server, a second portion corresponding to the product/service to which the advertisement pertains, and/or a third portion corresponding to the particular advertising clip. In this fashion, the cached advertisement content may be stored in an array organized according to the media server from which the content originates, the product/service to which the content is directed, or any other differentiating criteria.

Process 300 continues to block 330 where a request for streaming media may be transmitted to the media server. In one embodiment, this may be initiated by the user using a particular input. It should of course be understood that a streaming media request may be made in any variety of ways, including for example, selecting an icon associate with desired streaming content from within a browser application while the client device is connected to a server over a network.

Once a valid request is transmitted to and processed by a media server (e.g., server 20), process 300 may continue to block 340 where the locally cached advertising content associated with the requested streaming media may be presented to the user at block 340 using, for example, a media player application as described above. In one embodiment, the cached advertising content to be presented to the user may be selected by the server itself. In another embodiment, it may be selected randomly from a pool of available advertisements.

Since the cached advertising content presented at block 340 is locally available, playback thereof may begin without any network-related delay. In addition, all available bandwidth may be immediately allocated to the streaming of the request streaming media. To that end, at block 350, a media connection may then be setup between the requesting user device and the server at block 350, and the requested streaming media may begin to be downloaded while the advertising content from block 340 is still being presented. In one embodiment, this connection may include establishing any one of an HTTP, RTSP or UDP connection.

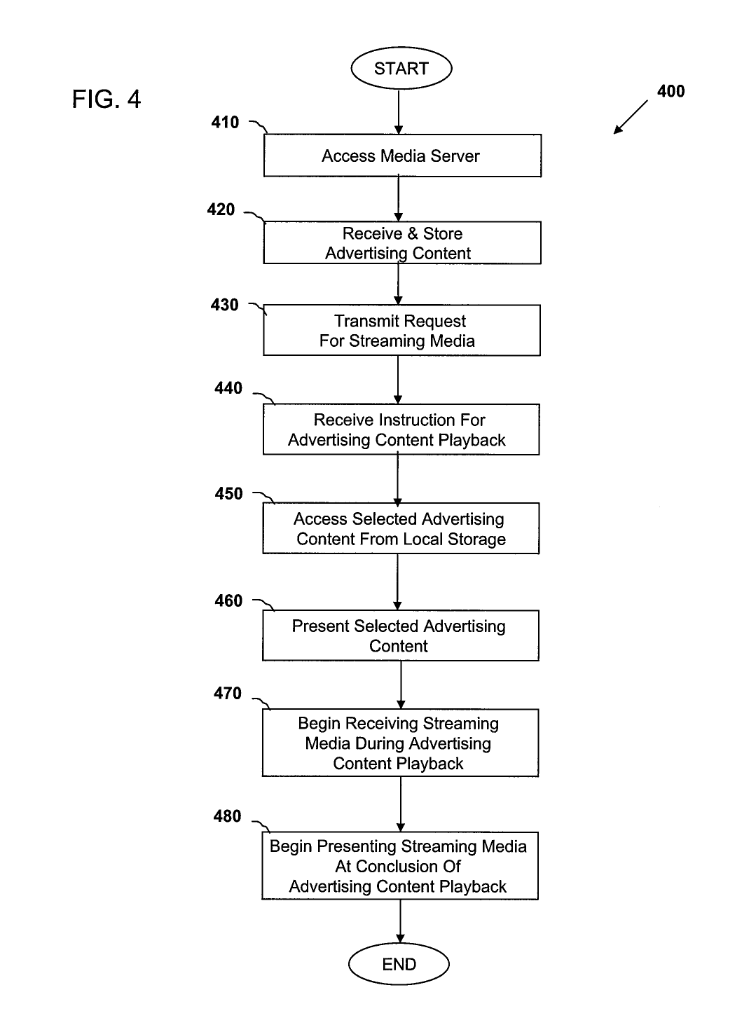

Referring now to FIG. 4, depicted is another embodiment of a process 400 for receiving streaming content in accordance with the principles of the invention. In this embodiment, process 400 begins at block 410 with the user device (e.g., user device 40) accessing a media server (e.g., server 20) over a network (e.g., network 50) in similar fashion to the operation of block 310 of FIG. 3, as described above. Once the server has been accessed, process 400 continues to block 420 where advertising content, such as advertising content 250, may be received from the server over the network. Thereafter, the advertising content may be cached or otherwise saved locally on the user device. It should further be appreciated that the downloaded/caching of this advertising content may occur automatically as a background application process and/or without the user's knowledge.

As described above with reference to block 320 of FIG. 3, the advertising content may be downloaded during idle communication periods, or otherwise inactive or bandwidth-rich periods. Such periods may be referred to as idle even though some relatively low amount of network activity may be occurring. It should further be appreciated that advertising content may be persistent between different sessions, and that the operation of block 420 may be to update already-stored advertising content. In this fashion, the advertising content may be dynamically changed based on availability of new content, a predetermined rotation of advertisements, or any other criteria.

It should be appreciated that the advertising content to be cached at block 420 may be in the form of one or more individual audio/video clips relating to different products and/or services. It should further be appreciated that each individual clip may be stored and catalogued in a local storage (e.g., local storage 220) of the user device using an advertisement identification number. In one embodiment, this advertisement identification number may be comprised of one or more of the following: a first portion corresponding to the accessed media server, a second portion corresponding to the product/service to which the advertisement pertains, and/or a third portion corresponding to the particular advertising clip. In this fashion, the cached advertisement content may be stored in an array organized according to the media server from which the content originates, the product/service to which the content is directed, or any other differentiating criteria.

Continuing to refer to FIG. 4, process 400 continues to block 430 where a request for streaming media may be transmitted to the media server. In one embodiment, this may be initiated by the user using a particular input. It should of course be understood that a streaming media request may be made in any variety of ways, including for example, selecting an icon associate with desired streaming content from within a browser application while the client device is connected to a server over a network

In response to the transmitted request from block 430, the user device may receive an instruction at block 440 from the server indicating which advertising content/clip should be presented to the user for the particular streaming media requested. In the case where advertising content has been stored in an array, there may be several choices from which to select. The selection criteria may be based on the server providing the requested streaming media, the requested streaming media, a predetermined rotation of the cached advertising content, a random selection of the cached advertising content, or any other selection criteria.

In any event, once an instruction or indication from the server has been received at block 440, process 400 may continue to block 450 where the selected advertising content may be accessed from a local storage device (e.g., local storage 220). Once accessed, the selected advertisement content may be immediately presented to the user at block 460 using, for example, a media player application as described above. Since the selected advertising content is locally available, virtually no network-related latency may be experience by the user between the time the streaming media request is made and the time the advertising clip begins to play.

Process 400 may then continue to block 470 where a media connection may then be setup between the requesting user device and the server, and where the requested streaming media may begin to be downloaded/streamed while the advertising content of block 460 is still being presented. Moreover, since the advertising content is being presented from a local storage device or memory, the requested streaming media does not have to compete with any other content for available bandwidth.

Process 400 concludes at block 480 with the presentation of the requested streaming media directly after the conclusion of the advertisement playback. Again, since the requested streaming media was allowed to queue in the background of the presentation of the advertisement content, delay-free presentation of the requested streaming media is provided.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A user device comprising:
a network interface configured to connect the user device to a network;
a display;
a local storage; and
a processor electrically connected to the network interface, the display and the local storage, the processor configured to cause the user device to,
access a server over the network using the network interface,
receive, automatically, advertising content from the server, wherein the advertising content is associated with streaming media content,
store the advertising content in the local storage,
transmit a request for the streaming media content to the server based on a user request,
present the advertising content on the display in response to said request for streaming media content, and
receive the requested streaming media content during presentation of at least a portion of the advertising content.

2. The user device of claim 1, wherein the advertising content comprises at least one audio/video digital media clip.

3. The user device of claim 1, wherein the processor is further configured to store the advertising content in an array of advertising clips.

4. The user device of claim 3, wherein the array of advertising clips is organized according to at least one of the media server from which the advertising content originates and the product/service to which the advertising content is directed.

5. The user device of claim 1, wherein the processor is further configured to automatically receive the advertising content using a background application process.

6. The user device of claim 1, wherein the processor is further configured to automatically receive the advertising content in response to an indication from the server that the advertising content should be received.

7. The user device of claim 1, wherein the processor is further configured to automatically receive the advertising content during an idle communication period.

8. The user device of claim 1, wherein, prior to presenting the advertising content, the processor is further configured to receive an instruction from the server indicating what advertising content is to be presented.

9. The user device of claim 8, wherein the advertising content comprises a plurality of advertising clips, and wherein the processor is further configured to selected from among the plurality of advertising clips based on said instruction from the server.

10. The user device of claim 1, wherein the processor is further configured to present the requested streaming media content without delay following the advertising content presentation.

11. A method for streaming media from a server to a user device over a network, the method comprising the acts of:
accessing, by the user device, the server over the network;
receiving, automatically, advertising content from the server, wherein the advertising content is associated with streaming media content;
storing the advertising content in a local storage of the user device;
transmitting a request for the streaming media content to the server based on a user request;
presenting at least a portion of said advertising content on the display in response to said request, and
receiving the requested streaming media content during said presenting of the advertising content.

12. The method of claim 11, wherein the advertising content comprises at least one audio/video digital media clip.

13. The method of claim 11, wherein storing the advertising content comprises storing the advertising content in an array of advertising clips.

14. The method of claim 13, wherein the array of advertising clips is organized according to at least one of the media server from which the advertising content originates and the product/service to which the advertising content is directed.

15. The method of claim 11, wherein receiving, automatically, the advertising content comprises receiving, automatically, the advertising content using a background application process.

16. The method of claim 11, wherein receiving, automatically, the advertising content comprises receiving, automatically, the advertising content in response to an indication from the server that the advertising content should be received.

17. The method of claim 11, wherein receiving, automatically, the advertising content comprises receiving, automatically, the advertising content during an idle communication period.

18. The method of claim 11, wherein, prior to presenting the advertising content, the method further comprises receiving an instruction from the server indicating what advertising content is to be presented.

19. The method of claim 18, wherein the advertising content comprises a plurality of advertising clips, and wherein the method further comprises selecting from among the plurality of advertising clips based on said instruction from the server.

20. The method of claim 11, further comprising presenting the requested streaming media content without delay following the advertising content presentation.
